(19) United States
(12) Patent Application Publication
(10) Pub. No.: US 2008/0167082 A1
(43) Pub. Date: Jul. 10, 2008

(54) Incorporated indicating arrangement for a mobile device and related methods

(76) Inventors: Vladimir Gurevich, Stony Brook, NY (US); David Shi, Stony Brook, NY (US); Heng Zhang, Holbrook, NY (US)

Correspondence Address: FAY KAPLUN & MARCIN, LLP, 150 BROADWAY, SUITE 702, NEW YORK, NY, 10038, US

(21) Appl. No.: 11/687,350

(22) Filed: Mar. 16, 2007

Related U.S. Application Data
(60) Provisional application No. 60/884,324, filed on Jan. 10, 2007.

(51) Int. Cl. H04M 1/00

(52) U.S. Cl. 455/566

(57) ABSTRACT

Described are an incorporated indicating arrangement for a mobile device and related methods. The mobile device comprises a housing and a processor situated in the housing. The mobile device further comprises a display arrangement disposed at least partially on a periphery of the housing. The display arrangement performs at least one of displaying first data to a user and receiving second data from the user. The display arrangement further provides an indication to the user, the indication being determined by the processor as a function of one of a functionality of the mobile device, a state of the functionality, preset configurations, and programmed configurations.

### PRIORITY CLAIM

This application claims the priority to the U.S. Provisional Application Ser. No. 60/884,324, entitled “System and Method for an Incorporated Indicating Arrangement,” filed Jan. 10, 2007. The specification of the above-identified application is incorporated in its entirety herewith by reference.

### FIELD OF THE INVENTION

The present invention relates generally to an incorporated indicating arrangement for a mobile device and related methods.

### BACKGROUND

A mobile device includes a display to provide a visual interface for interactions with a user. The user may interact with the visual interface using various types of data input arrangements such as keypads, touch pads, etc. The mobile device may also include indicators (e.g., LEDs) providing the user with information as to the state of a utilized functionality. For example, a cellular phone may continuously blink green to indicate a connection to a network, held red to indicate a disconnection to a network or a call being dialed, etc. These indicators are connected to a central processor that determines the nature of indication (e.g., different colors, amount of time between indications, etc.). Advances in mobile device technology have decreased the size/weight of mobile devices allowing users to conveniently utilize the mobile device. However, the size of the mobile device may be restricted because a separate indicator may be disposed at least partially within the mobile device. The separate indicator may further occupy at least one of the limited pins of an integrated circuit incorporating the processor of the mobile device.

### SUMMARY OF THE INVENTION

The present invention relates to an incorporated indicating arrangement for a mobile device and related methods. The mobile device comprises a housing and a processor situated in the housing. The mobile device further comprises a display arrangement disposed at least partially on a periphery of the housing. The display arrangement performs at least one of displaying first data to a user and receiving second data from the user. The display arrangement further provides an indication to the user, the indication being determined by the processor as a function of one of a functionality of the mobile device, a state of the functionality, preset configurations, and programmed configurations.

### DESCRIPTION OF THE DRAWINGS

FIG. 1 shows a top view of a mobile device according to an exemplary embodiment of the present invention.

FIG. 2 shows a perspective view of the mobile device of FIG. 1.

FIG. 3 shows a first view of inner components for the mobile device of FIG. 1.

FIG. 4 shows a second view of inner components for the mobile device of FIG. 1.

FIG. 5 shows a third view of inner components for the mobile device of FIG. 1.

FIG. 6 shows a method for indication according to an exemplary embodiment of the present invention.

### DETAILED DESCRIPTION

The present invention may be further understood with reference to the following description and the appended drawings, wherein like elements are referred to with the same reference numerals. The exemplary embodiments of the present invention describe an incorporated illumination arrangement for a mobile device (e.g., computing device, personal computer, laptop, pager, mobile device, cell phone, radio frequency identification device, scanner, etc.) to, for example, indicate a state of a functionality. According to the exemplary embodiments of the present invention, the illumination arrangement is incorporated into the display of the mobile device, thereby alleviating the need for a separate indicator (e.g., LED). One exemplary embodiment of the present invention sets to further the convenience of use through incorporation of the indicator with the display of the mobile device. The illumination arrangement will be discussed in more detail below.

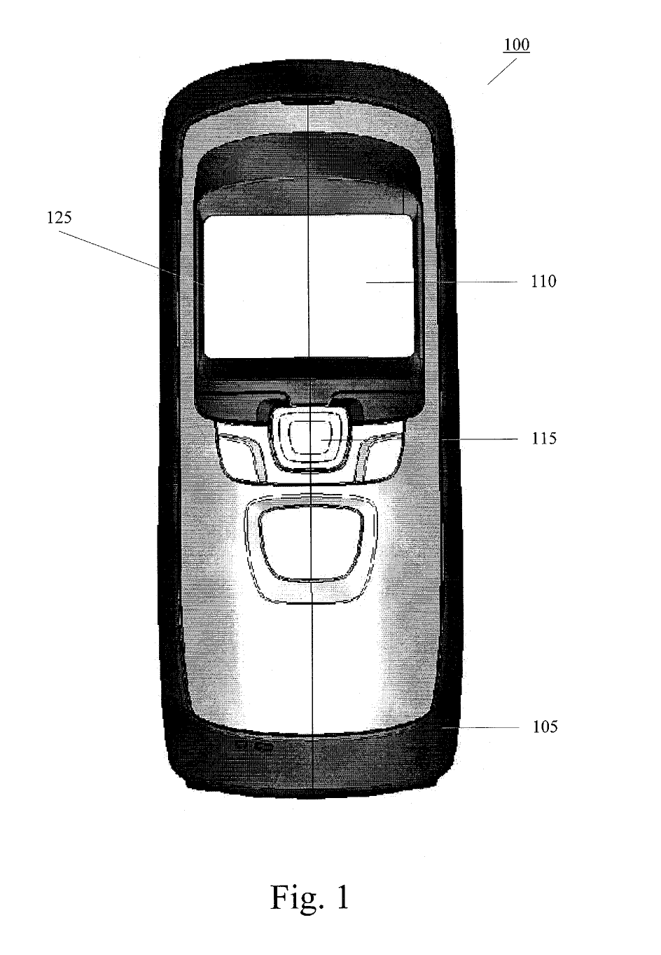

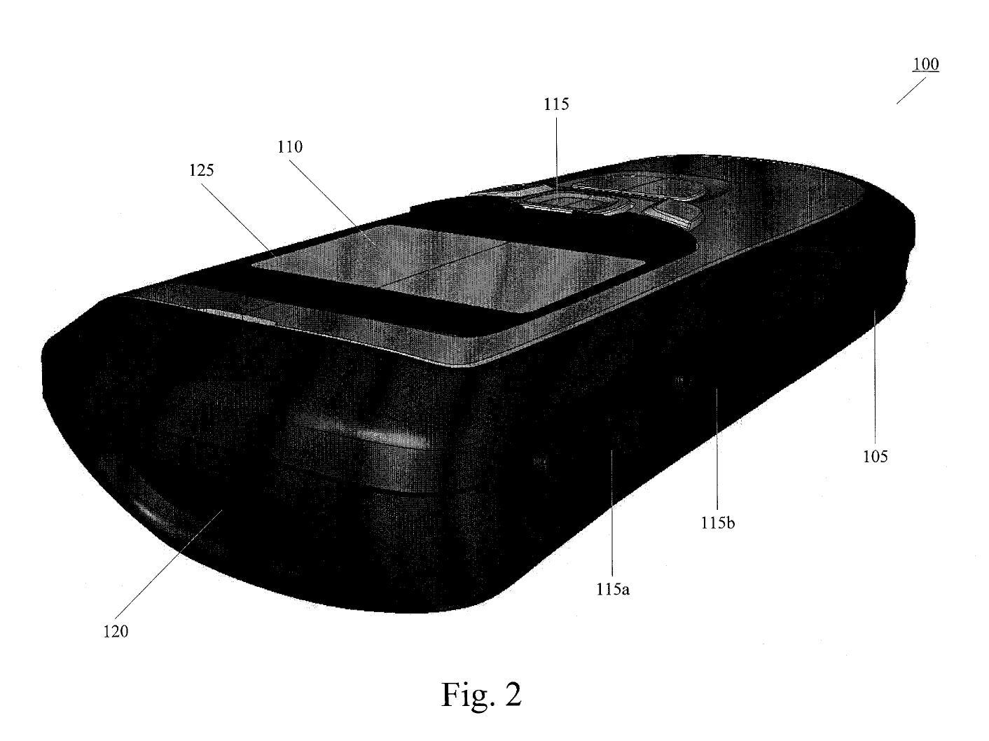

FIG. 1 shows a top view of a mobile device 100 according to an exemplary embodiment of the present invention and FIG. 2 shows a perspective view of the mobile device 100 of FIG. 1. It should be noted that the use of the mobile device 100 is only exemplary. The present invention may be applied to any system (whether such a system is mobile or stationary) that uses an indicator including the examples cited above.

In the exemplary embodiment of FIG. 1, the mobile device 100 includes a housing 105, a display 110, a data input arrangement 115, and a window 125. The housing 105 is a casing that holds at least partially the components of the mobile device 100. The display 110 provides a visual interface for the user. The display 110 will be discussed in more detail below. The data input arrangement 115 allows a user to input data (e.g., for a plurality of functionalities available on the mobile device 100, for hardware devices coupled to the mobile device 100, etc.). The window 125 may be transparent to allow a user to view the contents of the display 110 while providing a protective surface to prevent damage to the display 110.

In the exemplary embodiment of FIG. 2, the mobile device 100 may further include a data acquisition device (“DAD”) 120 (e.g., laser-based scanner, barcode scanner, image capturing device, etc.) along a top side of the mobile device 100. It should be noted that the DAD 120 is only exemplary and is used to indicate that the mobile device 100 may include further hardware devices disposed on or in the housing 105 to increase the available functionalities. Furthermore, it should be noted that the disposition of the DAD 120 on the top side of the mobile device 100 is only exemplary and may be disposed in or on any location of the mobile device 100. In the exemplary embodiment of FIG. 2, the mobile device 100 further includes a side data input arrangement (SDIA) 115a/b. The SDIA 115a/b may be used to activate/deactivate hardware devices such as the DAD 120 (e.g., via the SDIA 115b), scroll through menus (e.g., via the SDIA 115a), etc. Furthermore, it should be noted that the SDIA 115a/b is only exemplary and is used to indicate that the mobile device 100 may include data input arrangements anywhere on the mobile device 100.

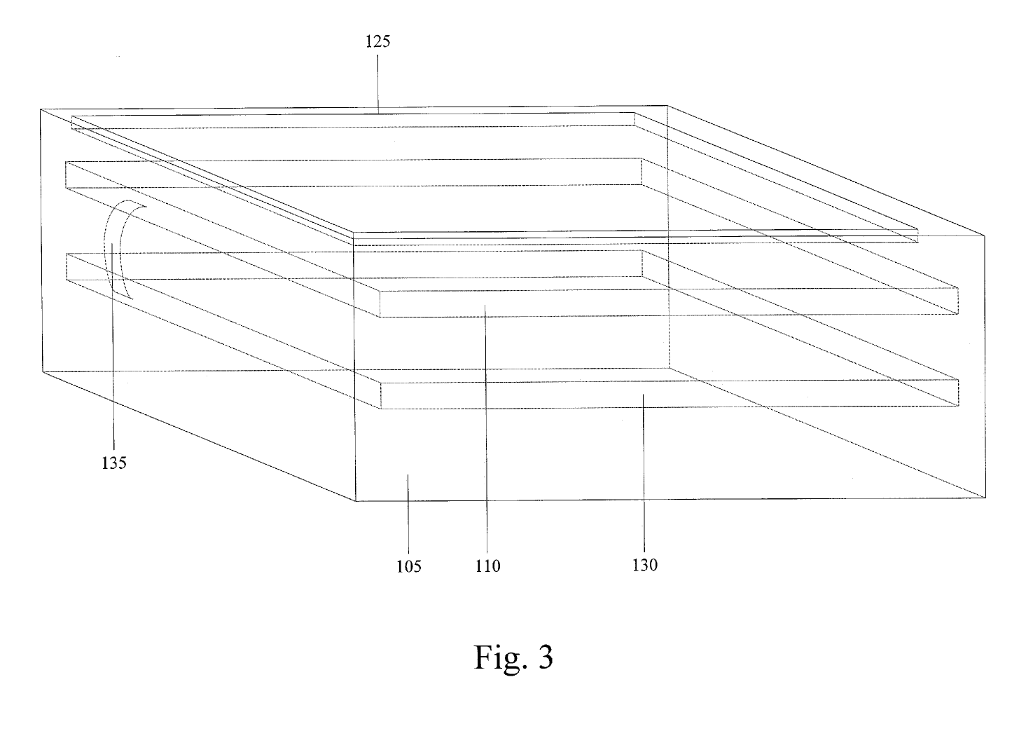

FIG. 3 shows a first view of inner components for the mobile device 100 of FIG. 1. In this exemplary embodiment, the inner components for the mobile device 100 include the display 100, a window 125, a processor 130, and a data cable 135. As discussed above, these components may be on or in the housing 105, either partially or wholly. It should be noted that the mobile device 100 may include further components. For example, the DAD 120, an antenna, a memory, etc. may be included within the mobile device 100. In addition, further hardware components may be connected (e.g., hardwired, wirelessly) to the mobile device 100. The window 125 serves to provide a barrier to protect the display 100. The window 125 is transparent to allow the data shown on the display 110 to be viewable by the user. The data cable 135 connects the processor 130 to the display 110 and facilitates an exchange of data signals.

The mobile device 100 may perform a plurality of functionalities. For example, the mobile device 100 may include communication devices (not shown) that, for example, dial outgoing calls or receive incoming calls. In another example, the mobile device 100 may include the DAD 120 that may be, for example, a laser capturing device (e.g., barcode scanner), an image/video capturing device (e.g., camera), a radio frequency identification device (RFID), etc. Depending on the functionality being utilized at a given time, the processor 130 determines the visual interface shown on the display 110 via the data cable 135.

The display 110 may include a backlight consisting of LEDs. The LEDs may include the colors of the visual spectrum (ROYGBIV), select colors of the visual spectrum (RGB), a single color of the visual spectrum (B), etc. The backlight provides an illumination for the display 110 to allow a user to view the contents shown on the display 110. Those skilled in the art will understand that a backlight is often used in an environment where the ambient lighting is insufficient to view the contents on the display 110. The present invention also utilizes the LEDs of the backlight as an indicator. That is, depending on the functionality, the state of the functionality, programmed configurations, and/or preset configurations, the LEDs of the backlight shine a corresponding color, shine in various intervals, etc. For example, if the communication functionality is being utilized, the backlight may shine red to indicate a call being dialed.

It should be noted that the use of the entire backlight is only exemplary. The present invention may utilize portions of the backlight as the indicator. For example, a single corner of the backlight on the display 110 may be used as the indicator. In another example, multiple corners may be used. In an exemplary embodiment, a first corner may signify the DAD is warming up, a second corner may signify the DAD is in use, a third corner may signify a successful scan, and a fourth corner may signify an unsuccessful scan. In yet another example, patterns may be incorporated into the indicator such as the backlight shining predetermined configurations (e.g., words, symbols, etc.). That is, the LEDs that create the predetermined configuration are activated. Furthermore, because the indicator is incorporated in the display, the manner in which the indicator indicates may be adjustable by the user. For example, the corner method discussed above may be selected, the predetermined configuration method may be selected, a combination thereof, etc.

In one exemplary embodiment of the present invention, as discussed above, the indicator may also show the state of the functionality. For example, if the DAD 120 is a scanner, the backlight may shine a first color (e.g., blue) to indicate that the scanning engine is preparing. A second color (e.g., green) may be shown to indicate that the scanning engine is capturing a scan. A third color (e.g., white) may be shown to indicate that the DAD 120 successfully captured the scan while a fourth color (e.g., red) may be shown to indicate that the DAD 120 did not capture the scan. It should be noted that the use of different colors is only exemplary and single color backlights may also accomplish the indication of state. For example, the backlight may shine a single color with various timed gaps (e.g., constant shining indicates the DAD 120 is scanning, rapid shining with short gaps indicates the DAD 120 did not capture a scan, slow shining with long gaps indicates the DAD 120 successfully captured the scan, etc.).

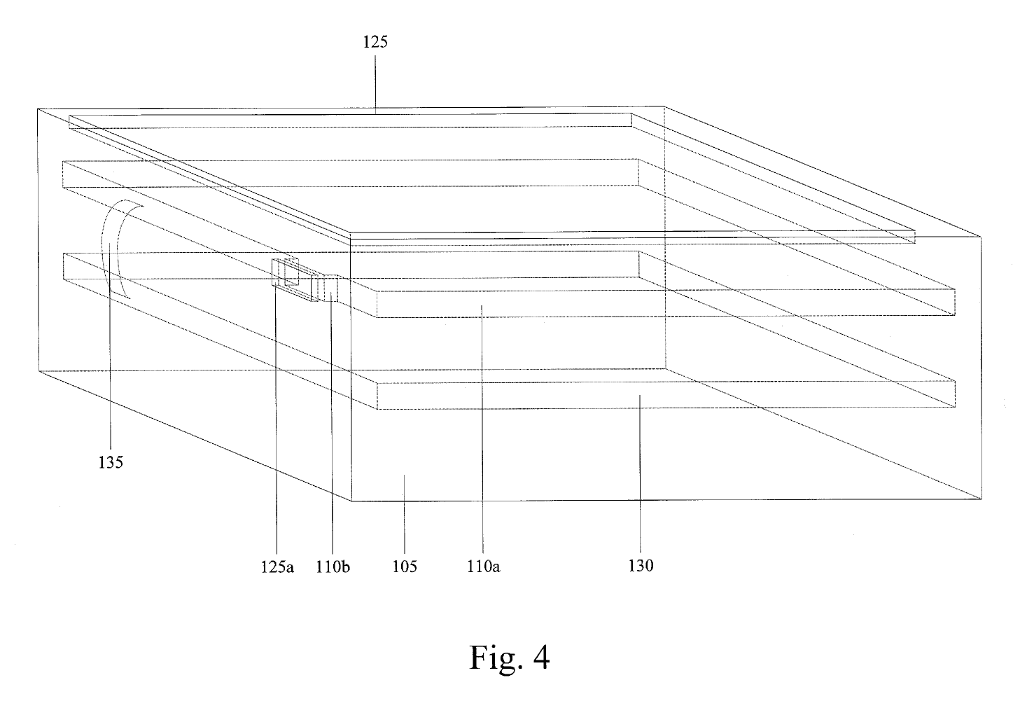

FIG. 4 shows a second view of inner components for the mobile device 100 of FIG. 1. In this exemplary embodiment, the inner components include the housing 105, the window 125, the processor 130, and the data cable 135. A display 110a of FIG. 4 is substantially similar to the display 110 of FIG. 3. However, the display 110a includes a further display area 110b. The further display area 110b is illustrated as showing data on a surface perpendicular to the main area of display 110a. However, it should be noted that the further display area 110b may be disposed on any side (e.g., common or different) of the display 110a so long as a user recognizes the further display area 110b differs from the main area of display 110a. The further display area 110b may be viewed via a window 125a. The window 125a functions substantially similar to the window 125.

In the exemplary embodiment of the second view, the backlight of the display 110a also serves as an illumination feature for users. The incorporated indicator may be embodied in the further display area 110b. For example, LEDs may shine a different color to indicate a state of a functionality, a common color may be shown at various intervals, a combination thereof, etc. In such an embodiment, the display 110a is still responsible for the indicating arrangement.

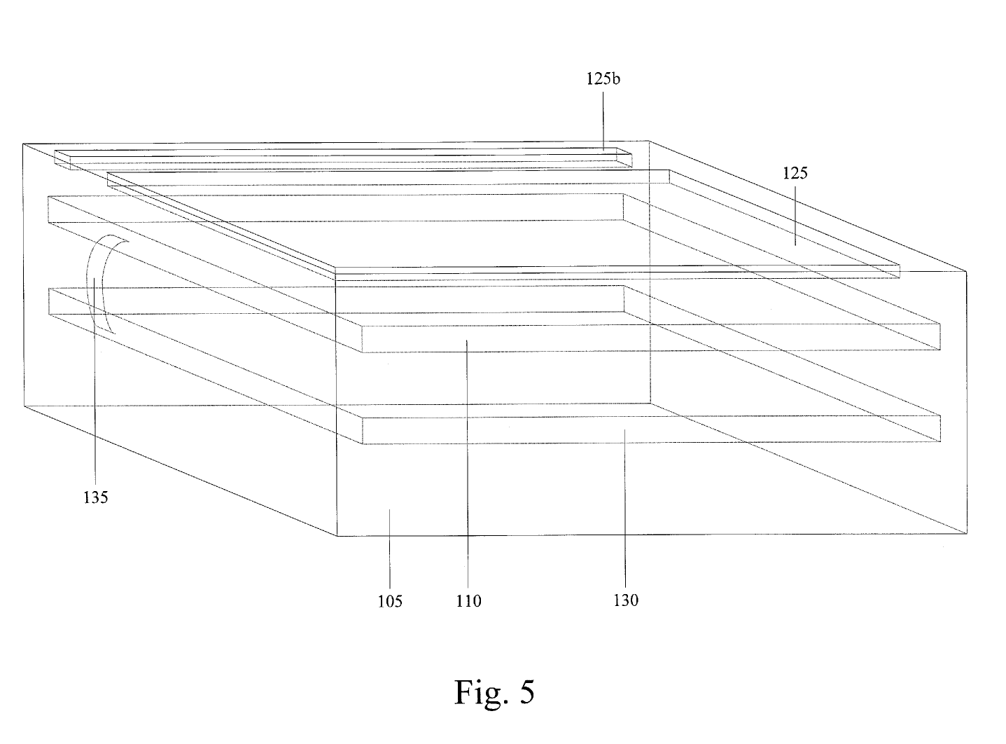

FIG. 5 shows a third view of inner components for the mobile device 100 of FIG. 1. In this exemplary embodiment, the inner components include the housing 105, the display 110, the window 125, the processor 130, and the data cable 135. The third view further includes a window 125b that functions substantially similar to the window 125. The window 125b may be disposed on a common surface of the housing 105 as the window 125. Thus, utilizing the display 110 with a single viewable surface (in contrast to the display of FIG. 4 with at least two viewable surfaces, 110a-b), at least two different sets of data may be shown. A first set of data may be, for example, data regarding the functionality the mobile device 100 is performing. The first set of data may be shown through the window 125. A second set of data may be, for example, data regarding an indication of the functionality. That is, the second set of data may be the incorporated indicator shown through the window 125b. It should be noted that the window 125b extended a substantially similar length as the window 125 is only exemplary and the window 125b may only extend a partial length. That is, the size of the window 125b may be designed to occupy a minimal area that still allows a user to recognize the indication of the functionality.

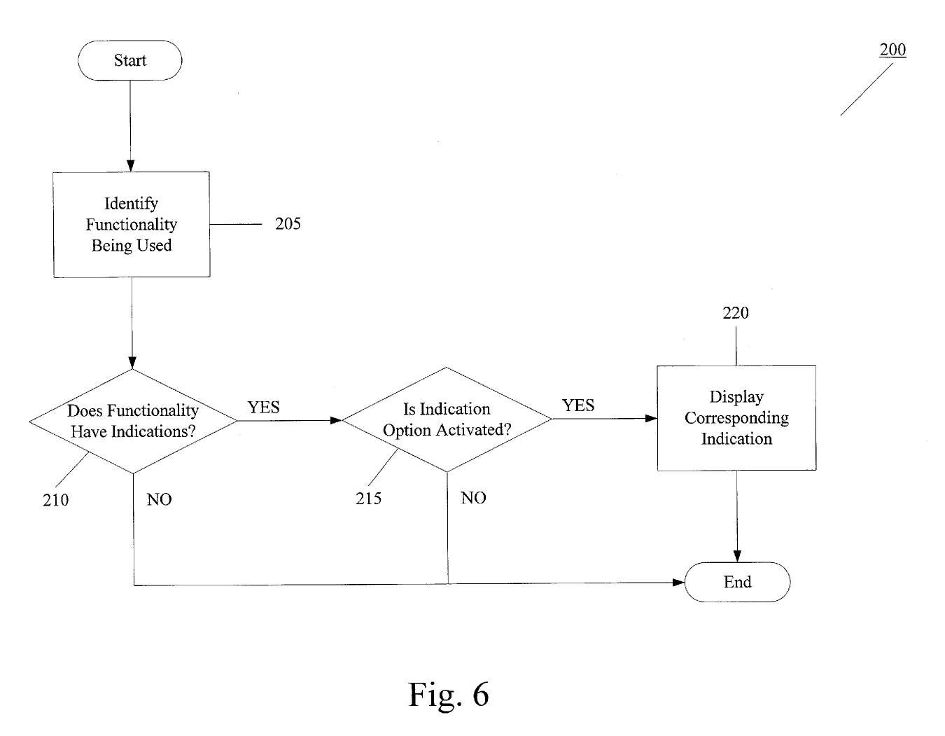

FIG. 6 shows a method 200 for indication according to an exemplary embodiment of the present invention. Although the method 200 may be applied to any exemplary embodiment where the indicator is incorporated into the display, the method 200 will be described with reference to the components of FIGS. 3-4.

The method 200 first identifies the functionality being used at step 205. The processor 130 may perform this identification. Upon identifying the functionality, step 210 determines if the functionality includes any indications. Those skilled in the art will understand that it may be inefficient to run indications for every functionality available on the mobile device 100. However, a user may utilize a functionality more efficiently if the functionality includes a simple indication (e.g., connection/disconnection for cell phone networks) or a complex indication (e.g., state of scan for a scanner).

If step 210 determines that the functionality does not include indications, the method 200 ends. If step 210 determines that the functionality does include functionalities, the method 200 continues to step 215. At step 215, a determination is made whether the indication option is activated. It should be noted that the indicator may be toggled on/off depending on the user. For example, if a user finds that the indicator is distracting, the user may toggle the indicator off. This may lengthen battery life. However, it should also be noted that the indicator may be a permanent feature of the mobile device 100 and step 215 may be absent.

If step 215 determines that the indicator is deactivated, the method 200 ends. If step 215 determines that the indicator is activated, the method 200 continues to step 220. At step 220, a corresponding indication is displayed. As discussed above, because the indicator is incorporated into the backlight of display 110 or the further display area 110b of display 110a, the processor 130 sends a signal to the respective display via the data cable 135. Also as discussed above, the signal may be a function of the functionality, the state of the functionality, programmed configurations, preset configurations, display restrictions/limitations (e.g., certain areas must be used for display purposes only), etc.

The present invention affords further advantages over conventional mobile devices. The incorporation of the indicator into the display allows the elimination of a separate indicator (e.g., LEDs). An overall smaller, compact design for the mobile device 100 may thus be achieved. In addition, the processor is relieved of a connection to the indicator. The processor is only required to send the appropriate signal to the display, rather than to the display and the indicator. Furthermore, if the processor includes an integrated circuit, at least one pin may be freed to allow a connection to another hardware device. It should be noted that the above described advantages are only exemplary and that other advantages exist for the incorporated indicating arrangement. For example, the mobile device is not restricted to the colors available on the indicator but may utilize the colors available on the display. Furthermore, preconfigured arrangements (e.g., words, shapes) may be used as the indication instead of being limited to an activation/deactivation of a single LED.

Although the present invention is described with reference to incorporating the indicator into the display of the mobile device, those skilled in the art will understand that the indicator may be incorporated according to the above described exemplary embodiments into any component that utilizes, for example, a lighting arrangement with LEDs. For example, the mobile device may include a data input arrangement with keys that illuminate, thereby allowing a user to utilize the data input arrangement in any ambient lighting condition. The keys may be illuminated with LEDs. Thus, according to the present invention, the LEDs of the data input arrangement may further function as the incorporated indicating arrangement. Similar to the above described exemplary embodiments, the indicator may be incorporated into a single key, multiple keys (allowing predetermined configurations to be used), a combination thereof, etc.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A mobile device, comprising:
a housing;
a processor situated in the housing; and
a display arrangement disposed at least partially on a periphery of the housing, the display arrangement performing at least one of: displaying first data to a user and receiving second data from the user, the display arrangement further providing an indication to the user, the indication being determined by the processor as a function of one of a functionality of the mobile device, a state of the functionality, preset configurations, and programmed configurations.

2. The mobile device of claim 1, wherein the display arrangement includes:
a first window disposed at least partially on the periphery of the housing; and
a display disposed within the housing, the display being positioned to display the first data through the first window.

3. The mobile device of claim 2, wherein the display is positioned to further display the indication through the first window.

4. The mobile device of claim 2, wherein the display arrangement further comprises:
a second window disposed at least partially on the periphery of the housing on a common surface as the first window, the display being positioned to display the indication through the second window.

5. The mobile device of claim 4, wherein the display has one viewable surface.

6. The mobile device of claim 2, wherein the display arrangement further comprises:
a perpendicular window disposed at least partially on the periphery of the housing on a different surface as the first window, the display being positioned to display the indication through the perpendicular window.

7. The mobile device of claim 6, wherein the display has at least two viewable surfaces, a first surface displaying the first data and a second surface providing the indication.

8. The mobile device of claim 1, further comprising:
a data cable connecting the processor to the display arrangement to facilitate an exchange of data signals.

9. The mobile device of claim 1, wherein the indication is an illumination.

10. The mobile device of claim 9, wherein the illumination is a single color, a plurality of colors, a varied time lighting, and a combination thereof.

11. The mobile device of claim 1, wherein the functionalities are performed using at least one of a data acquisition device and a communications device.

12. A method for indication for a mobile device, comprising:
performing, by a display arrangement, at least one of: displaying first data to a user and receiving second data from the user; and
providing, by the display arrangement, an indication to the user, the indication being determined as a function of one of a functionality of the mobile device, a state of the functionality, preset configurations, and programmed configurations.

13. The method of claim 12, further comprising:
determining the state of the functionality by a processor.

14. The method of claim 12, wherein the display arrangement includes a first window and a display.

15. The method of claim 14, wherein the first set of data is displayed by the display through the first window.

16. The method of claim 14, wherein the indication is provided by the display through the first window.

17. The method of claim 14, wherein the indication is provided by the display through a second window, the first and second windows disposed on a common surface of the mobile device.

18. The method of claim 14, wherein the indication is provided by the display through a perpendicular window, the display having at least two viewable surfaces, a first surface displaying the first data and a second surface providing the indication.

19. The method of claim 12, wherein the indication is illuminated.

20. The method of claim 12, wherein the illumination is one of a single color, a plurality of colors, a varied time lighting, and a combination thereof.

21. A mobile arrangement, comprising:
storing means;
processor situated in the storing means; and
display means at least partially on a periphery of the storing means, the display means performing at least one of: displaying first data to a user and receiving second data from the user, the display means further providing an indication to the user, the indication being determined by the processor as a function of one of a functionality of the mobile arrangement, a state of the functionality, preset configurations, and programmed configurations.
